(19) United States
(12) Patent Application Publication
(10) Pub. No.: US 2013/0015143 A1
(43) Pub. Date: Jan. 17, 2013

(54) NON-DESTRUCTIVE METHOD FOR ALGAE CONTAMINATED WATER TREATMENT AND ALGAE HARVEST OR REMOVAL

(71) Applicants: Sijing Wang, Pudong (CN); Qing Zhao, Pudong (CN); Guixi Zhang, Pudong (CN)

(72) Inventors: Sijing Wang, Pudong (CN); Qing Zhao, Pudong (CN); Guixi Zhang, Pudong (CN)

(21) Appl. No.: 12/810,256

(22) PCT Filed: Apr. 5, 2010
(86) PCT No.: PCT/CN2010/000440

§ 371 Date: Jun. 23, 2010

(51) Int. Cl. C02F 1/56; A01G 7/00

(52) U.S. Cl. 210/728; 47/1.4

(57) ABSTRACT

A method of treating an algal containing aqueous medium comprises adding an effective amount of the treatment composition to the aqueous medium wherein the treatment composition comprises 1) a) a water soluble cationic quaternary ammonium starch or b) a water soluble quaternary ammonium starch/gum blend or c) a water soluble modified tannin and 2) a metal containing inorganic coagulant. In certain aspects of the invention, the so-treated algal containing aqueous medium is filtered such as by microfiltration and/or ultrafiltration to result in potable water. In another aspect of the invention, the algal containing aqueous medium is an agglomerated mass of algae with water dispersed throughout the mass. The method comprises a step of separating the algae from the water, thereby harvesting the algae for further processing such as may ultimately lead to the production of biodiesel fuel.

### FIELD OF THE INVENTION

The invention pertains to methods for treating aqueous systems that contain algae. The methods may be used, for example, for treatment of algae contaminated water systems or to aid in effective algae harvest.

### BACKGROUND OF THE INVENTION

In both industrial and municipal water treatment plants, microbial control and reduction is often a necessary step to ensure that the treated water meets its required quality. In many water treatment systems, microbial content may be reduced via a variety of methods including filtration steps such as microfiltration and ultrafiltration.

One of the more common problems in water treatment plants is the growth of algae in various operations such as in clarifiers, or filters, or in basins. Algae come in many types including filamentous algae, such as Cladaphora and Spirogyra, planktonic algae such as Microcystis and Anabaena, branched algae such as Chara vulgaris and Nitellam, swimming pool algae commonly referred to as black, brown, and red algae, and algae found in ponds such as Dictyosphaerium, Spirogyra, Oedogonium, Chlorococcum, Pithaophora, Hyudrodictyon and Lyngbya.

Municipal water plants treat raw water and convert it to potable water for human consumption. It is not uncommon to see a municipal water plant clarifier or basin with an accumulation of algae around its peripheral walls, and filamentous algae growths several feet long. Algae blooms have been noted to appear literally overnight in such systems under the right temperature and sunlight conditions and, if left untreated, will cause taste and odor problems in the finished waters.

A variety of known treatments are effective in killing the algae but, as a result, these treatments release algae toxins, e.g., microcystins into the water. Release of these toxins is harmful to plant, animal, and human life alike:

Algae is also known to be one of the most efficient plants for converting solar energy into cell growth. During algae cell growth, chemical energy is used to drive synthetic reactions such as the formation of sugars or the fixation of nitrogen into amino acids for protein synthesis. Excess chemical energy is stored in the form of fats and oils and triglycerides. The creation of oil in algae only requires sunlight, carbon dioxide, and the nutrients needed to form triglycerides. Microalgal oils are produced by various means including biological conversions to lipids or hydrocarbons or by thermochemical liquidation of algal cells. Accordingly, algal harvesting is becoming ever more important as the world is attempting to provide viable alternatives to fossil based fuel.

When the algae is collected from an aqueous system such as a water treatment plant, natural body of water, or an aqueous nutrient containing medium, the collected algae contains an excess of water that must be removed so that the algae mass may be further processed such as by lysing to unbind the oil from the algae cells.

### BRIEF DESCRIPTION OF THE INVENTION

In accordance with one aspect of the invention, the method of treating an algal containing aqueous medium is disclosed wherein the treatment method comprises adding an effective amount of a treatment composition to the aqueous medium. The treatment composition comprises 1) a water soluble or dispersible cationic polymer and 2) a second component comprising a metal containing inorganic coagulant. In certain embodiments, the so-treated algal containing aqueous medium is subjected to a further filtering step or steps such as microfiltration and/or ultrafiltration.

In another aspect of the invention, the cationic polymer is selected from the group consisting of a) a water soluble cationic quaternary ammonium starch, b) a water soluble quaternary ammonium starch/gum blend, and c) a water soluble tannin containing cationic polymer and mixtures of a), b), and c).

As used herein, “cationic polymer” means a polymer having an overall positive charge. A cationic polymer may, in some instances, be prepared via vinyl addition polymerization of one or more cationic monomers with one or more nonionic monomers, or by polymerization of the cationic monomers with one or more anionic monomers and optionally one or more nonionic monomers to produce a resulting polymer having a net cationic charge. Cationic polymers can also be made via condensation polymerization synthesis routes.

In another aspect of the invention, the algal containing aqueous medium comprises an agglomerated mass of algae with water dispersed throughout the mass. The water is separated from the algae via use of the treatment composition of the invention, thereby harvesting the algae for further use such as a biofuel source.

### DETAILED DESCRIPTION

In one aspect of the invention, a method of treating algae containing water is provided. The method comprises adding to the water an effective amount of a treatment composition including 1) a cationic quaternary ammonium starch based coagulant or a cationic quaternary ammonium starch/gum based coagulant in combination with 2) a metal containing inorganic flocculant such as alum. In another aspect of the invention, the treatment composition is added to an algae contaminated aqueous medium so as to enhance filterability and membrane flux in water treatment systems employing either ultrafiltration and/or microfiltration techniques. The combined treatment possesses significant potential in municipal water treatment applications wherein the water is contaminated with blue-green algae. In such systems, the treatment not only reduces COD and TOC levels, but it also acts to reduce the algae toxin level related to microcystin content in the system water. As stated above, microcystins are very toxic to plants and animals, including humans.

Another exemplary embodiment of the invention is directed toward methods of dewatering algae masses by contacting same with the treatment composition, i.e., a 1) cationic polymer and 2) metal containing inorganic based coagulant. In these methods, the water content of the algae mass is reduced, and significantly, the algae is not killed or lysed so that microcystins are not released.

In another exemplary embodiment, the cationic polymer is selected from the groups a), b), and c) and mixtures of two or more of these components wherein a) is a water soluble cationic quaternary ammonium starch, b) is a water soluble quaternary ammonium starch/gum blend, and c) is a water soluble tannin containing polymer.

As stated above, algal harvesting and dewatering may be used to provide a biofuel source such as biodiesel. In another aspect of the invention, the treatment composition is used to improve the process for more efficient algae harvesting and dewatering to provide higher algae yields for subsequent use as biofuel source.

With regard to the cationic quaternary ammonium starch based coagulant component of the treatment composition, these are described in U.S. Pat. No. 4,088,600. Basically, as is set forth in the U.S. Pat. No. 4,088,600, the cationic quaternary starch (CQS) consists mainly of two moieties, namely a starch group and a quaternary ammonium salt group. The starch group may be prepared from a host of starches and starch fractions including acid or enzyme modified corn or waxy starches. Exemplary starches include those prepared from corn, potato, tapioca, sago, rice, wheat, waxy maize, grain sorghum, grain starches in raw or modified forms such as those modified with acids, oxidizing agents and the like; to amylose and amylpectin and to the linear and branched components respectively, of cornstarch and also to dextrins.

The quaternary ammonium compound used to form the CQS is generally of the formula:

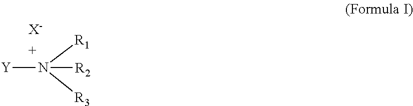

in which X⁻ is any monovalent anion, e.g., chloride, bromide, iodide, or methyl sulfate; Y is from the group consisting of 2,3-epoxy propyl, 3-halo-2-hydroxy propyl, 2 haloethyl, o, p, or m (α hydroxy-βhalo ethyl)benzyl; R₁, R₂, and R₃ are from the group consisting of hydrogen, hydroxyl, alkyl, substituted alkyl, aryl and arallkyl; in which two of the R's may be joined to form a heterocylic or homocyclic ring compound; in which the total number of carbons in all three of R₁, R₂, and R₃ should not exceed about 14 carbons. If all three of R₁, R₂ and R₃ are different, and R₃ contains more than 3 carbon atoms but not more than 12, then R₁ and R₂ should preferably be from the group consisting of methyl and ethyl; and if R₁ and R₂ are joined to form a ring compound, R₃ should preferably not be greater than ethyl.

The reaction to make the cationic starch involves the hydroxyl groups on the starch molecule and the reactive Y group of the quaternary ammonium reactant, so that the resulting cationic starch product has the formula

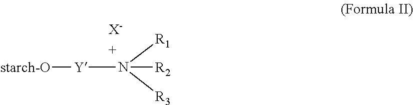

in which Y′ is the reaction residue of Y and X and the Rs (R₁, R₂, R₃) are unaltered. Y′ would thus be (typically) 2 hydroxyl propyl, ethyl, or o, p or m (α hydroxy-βhalo ethyl)benzyl.

In a typical case using N-(3-chloro-2-hydroxypropyl)trimethylammonium chloride, the reaction may proceed simplistically as

Starch —OH+ClCH₂—CH(OH)—CH₂ N⁺(CH₃)₃Cl⁻+NaOH→Starch —O—CH₂—CH(OH)—CH₂N⁺(CH₃)₃Cl⁻+NaCl+H₂O.

In one exemplary embodiment, a number of quaternary ammonium cationic starches may be prepared by reacting modified cornstarch with varying amounts of N-(3-chloro-2-hydroxy propyl)trimethyl ammonium chloride, with sodium hydroxide as catalyst. The degree of substitution (D.S.) of thee products is calculated theoretically and is found to be in the range of 0.1 to 0.45. The degree of substitution is defined as a number of moles of quaternary ammonium substituent, in this case

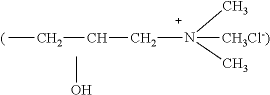

per anhydroglucose unit.

Exemplary quaternary ammonium cationic starches include those wherein the degree of substitution can be within the range of about 0.01 to 0.75 quaternary units conforming to Formula II given above, per anhydroglucose unit in the starch group. Preferably, it is about 0.1-0.45. One preferred CQS is commercially available and sold by GE. It is prepared via reaction of 3-chloro-2 hydroxpropyltrimethylammoniumchloride and “Melogel” corn starch. The corn starch is present in an amount of about 13.9% (by weight), with the “quat” present in an amount of about 18.2 wt %, and the polymer product contains about 31% actives (by weight). This CQS is designated herein as Polymer A. Another exemplary CQS is commercially available and sold by GE. It is prepared via reaction of 3-chloro-2-hydroxypropyltrimethylammonium chloride and a hydrolyzed starch. The acid hydrolyzed starch is present in an amount of about 16.6 wt %, and the product contains about 27% actives by weight. The “quat” is present in an amount of about 5.4 wt %.

In another aspect of the invention, the treatment composition includes a quaternary ammonium starch/gum mixture or blend (CQS & G), and this treatment is added to the desired aqueous medium that contains algae. The CQS & G mixtures are described in U.S. Pat. No. 5,248,449. These consist mainly of three components, namely: 1) a quaternary ammonium salt as described above; 2) a starch group as described above; and 3) a gum component. Generally, the CQS & G blends are prepared by reacting a mixture of starch and natural gum with the quaternary ammonium compound in the presence of an alkali catalyst at a pH in the range of about 12-13. One such exemplary CQS & G blend is commercially available and is sold by GE. It is a condensation product of 11.2% mixture of acid hydrolyzed starch/gum and 13.9 wt % 3-chloro-2-hydroxypropyltrimethylammonium chloride. The starch:guar gum ratio is about 6.6:1 by weight.

In one exemplary embodiment, the cationic quaternary ammonium starch and gum combinations contain between 0.7-3% preferably 1.0-2.1% by weight gum, 7-30% preferably, 12-16% by weight starch and a sufficient amount of the quaternary compound to assure a cationic charge in the range of about 0.2-2.0 meq/g, which amount is typically achieved with a weight percent of 2-50%, preferably 7-33%.

Suitable natural gums for use in this invention include, but are not limited to, carboxymethyl cellulose, guar, locust bean, karaya, alginate including propylene glycol algienate and sodium alginate and xanthum gum and is preferably guar, carboxymethyl cellulose, or alginate gum.

The synthesis reactions to produce the cationic quaternary ammonium modified starch-gum compositions of the instant invention generally involve reacting the hydroxyl groups on the starch and gum molecules with the reactive Y group of the quaternary ammonium reactant. Thus, for example, in a typical case where the gum is guar gum, the quaternary ammonium compound is N-(3-chloro-2-hydroxypropyl)trimethylammonium chloride, and the alkali is sodium hydroxide; the simplified reaction may be expressed as:

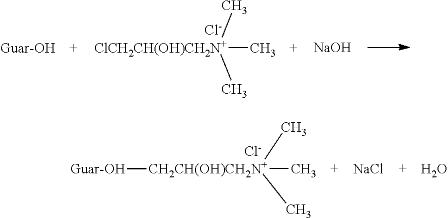

Similarly, the simplified reaction for the cationic starch may be expressed as follows:

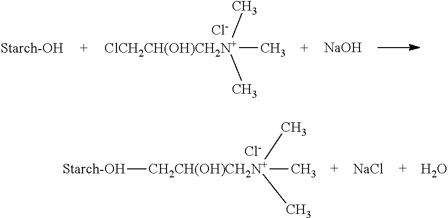

In order to form the water soluble quaternary ammonium starch/gum blends, the quaternary ammonium compound reactant is the same as set forth above. The starch and gum molecules are modified via the reaction so that the reactant bonds with the hydrogen atom available from the hydroxyl moiety on the gum or starch molecule. The ammonium modified starch therefore has the structure:

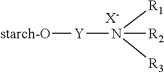

and the cationic quaternary ammonium modified gum has the formula:

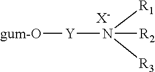

wherein Y, X⁻, R₁, R₂, and R₃ are all as previously defined. (See Formula I).

Exemplary CQS & G blends have a degree of substitution in the range of 0.1-1.8, preferably 0.2 to 1.2 wherein the degree of substitution (D.O.S.) is defined as the number of moles of quaternary ammonium substituent per anhydroglucose unit contributed by the starch and gums.

Exemplary combinations of the guar gum and starch components of the CQS & G treatment composition include weight ratios of cornstarch:gum (guar gum) between about 5-15 starch:1 gum. Exemplary ranges by weight of gum and starch are as follows: 0.7-3% gum and 7 to about 30 wt % starch. The viscosity of the blend should preferably not exceed about 10,000 cps. As to the dosages that may be employed, the CQS and CQS & G blends may each be added in an amount of about 5 to about 1,000 ppm of the treatment composition in the aqueous medium.

As to exemplary tannins that may be employed as one of the benign natural product coagulants, these may be obtained from various wood and vegetation materials found throughout the world. Tannins area large group of water-soluble complex organic compounds that naturally occur in leaves, twigs, barks, wood, and fruit of many plants and are generally obtained by extraction from plant matter. The composition and structure of tannins will vary depending on the source and method of extraction, but the generic empirical formula is represented by C₇₆H₅₂O₄₆. Examples of barks from which tannins can be derived are wattle, mangrove, oak, eucalyptus, hemlock, pine, larch, and willow. Examples of woods are the quebracho, chestnut, oak, mimosa, and urunday. Examples of fruits are myrobalans, valonia, divi-diva, tara, and algarrobilla. Examples of leaves are sumac and gambier. Examples of roots are canaigre and palmetto.

In one aspect of the invention, a water soluble or dispersible tannin containing polymer composition comprising a copolymer of a tannin and a cationic monomer is employed. In another embodiment of the present invention, the water soluble or dispersible tannin containing polymer composition comprises a polymer of tannin; a cationic monomer and an optional monomer selected from the group consisting of an anionic monomer and a nonionic monomer. These tannin polymers are described in U.S. Pat. No. 5,916,991.

As stated in the '991 U.S. Patent, the cationic monomer is selected from a group containing ethylenically unsaturated quaternary ammonium, phosphonium or sulfonium ions. Typical cationic monomers are quaternary ammonium salts of dialkylaminoalkyl(meth)acrylamides, dialkylaminoalkyl(meth)acrylates and diallyldialkyl ammonium chloride.

Exemplary cationic monomers include diethylaminoethyl(meth)acrylate, methyl chloride, dimethyl sulfate salt of diethylaminoethyl acrylate, dimethylaminoethyl acrylate methyl chloride (AETAC), dimethylaminoethyl methyacrylate methyl chloride (METAC), dimethylaminoethyl methacrylate (MADAME), dimethyaminopropyl(meth)acrylamide methyl chloride, diallyldimethyl ammonium chloride and diallyldiethyl ammonium chloride.

The anionic monomer, when present, is selected from the group containing ethylenically unsaturated carboxylic acid or sulfonic acid functional groups. These monomers include but are not limited to acrylic acid, methacrylic acid, vinyl acetic acid, itaconic acid, maleic acid, allylacetic acid, styrene sulfonic acid, 2-acrylamido-2 methyl propane sulfonic acid (AMPS®) and 3-allyloxy-2hydroxypropane sulfonic acids and salts thereof.

The nonionic monomer, when present, is selected from the group of ethylenically unsaturated nonionic monomers which comprise but are not limited to acrylamide, methacrylamide, N-methylolacrylamide, N,N-dimethyl-acrylamide; lower alkyl (C₁-C₆) esters including vinyl acetate, methyl acrylate, ethyl acrylate, and methyl methacrylate; hydroxylated lower alkyl (C₁-C₆) esters including hydroxyethyl acrylate, hydroxypropyl acrylate and hydroxyethyl methacrylate; allyl glycidyl ether; and ethoxylated allyl ethers of polyethylene glycol, polypropylene glycol and propoxylated acrylates. The preferred nonionic monomers are allyl glycidyl ether and acrylamide.

The resulting tannin containing polymer contains from 10 to 80% by weight of tannin, 20 to 90% by weight of cationic monomer, 0 to 30% by weight of nonionic monomer and 0 to 20% by weight of anionic monomer, provided that the resulting tannin containing polymer is still water soluble or dispersible, and the total weight percent of cationic, nonionic and anionic monomers and tannin adds up to 100%. Preferably, when the cationic monomer and anionic monomer are present together in the tannin containing polymer, the cationic monomer comprises a greater weight percentage than the anionic monomer.

Exemplary cationic tannin copolymers include copolymers of tannin and cationic monomer wherein the copolymer contains from 50 to 90 wt % cationic monomer in the copolymer, provided the total weight of tannin and cationic monomers totals 100 wt %. These particular copolymers are most preferred when the tannin is a Mimosa type tannin and the cationic monomer is methyl chloride quaternary salt of dimethylaminoethyl acrylate (AETAC).

The number average molecular weight of the resulting tannin containing polymer is not critical as long as it is still water soluble or water dispersible. The tannin containing polymers may be prepared by mixing the desired monomers with tannin and initiating the polymerization by a free radical initiator via solution, precipitation, or emulsion polymerization techniques. Conventional initiators such as azo compounds, persulfates, peroxides, and redox couples may be used. One exemplary initiator is 2,2′azobis(2-amidinopropane)dihydrochloride and t-butyl hydroperoxide/sodium metabisulfite (t-BHP/NaMBS). These or other initiators may be added at the end of polymerization to further react with any residual monomers.

Chain transfer agents such as alcohol, amine, formic acid, or mercapto compounds may be used to regulate the molecular weight of the polymer. The resulting polymer may be isolated by well known techniques including precipitation, etc., or the polymer may simply be used in its aqueous solution.

The reaction temperature is not critical and generally occurs between 20° C. and 100° C., preferably 40° C. to 70° C. The pH of the reaction mixture is also not critical and is generally in the range of 2.0 to 8.0. The resulting tannin containing polymers are characterized by C-13 NMR, Brookfield viscosity and percent solids.

Noteworthy tannin copolymers are graft copolymers of AETAC and mimosa tannin wherein the AETAC monomeric repeat unit in the copolymer is present in an amount of by weight of greater than 50%. Such copolymers are available from GE with varying cationic charge densities of about 50%, 57.5%, and 70% (by weight) respectively. These copolymers range in MW from about 50,000-80,000 Daltons.

Another particularly noteworthy tannin is a tannin based polymeric coagulant which is comprised of N,N-(dimethylaminoethyl)methacrylate (MADAME) polymerized using t-butylhydroperoxide and sodium metabisulfite. The resulting polyMADAME is converted to hydrochloride and then blended/reacted in an aqueous medium with tannin to obtain a homogenous poly(MADAME)-tannin composition. The mole ratio of tannin/MADAME is about 1:0.5 to 1:50, with a preferred mole ratio of 1:1.5 to about 1:3. Molecular weight is from about 500 to about 2,000,000, preferably 5,000-200,000. These are available from GE.

Another exemplary tannin is comprised of monomer [2-(methacryloyloxy)ethyl]trimethylammonium chloride (METAC) polymerized using t-butylhydroperoxide and sodium metabisulfite. The resulting polyMETAC is then blended/reacted in an aqueous medium to obtain a homogenous poly(METAC)-tannin composition. The mole ratio of tannin/METAC is from about 1:0.5 to about 1:5.0 with a preferred mole ratio of 1:1.5 to about 1:3. Molecular weight of the polyMETAC is from about 500 to about 2,000,000 with a preferred molecular weight of about 5,000 to about 200,000.

Other exemplary tannin coagulants are those made via reaction of tannin, an amine, and an aldehyde such as those set forth in U.S. Pat. No. 4,558,080. In accordance with the '080 patent, these components are reacted at an acidic pH and where the molar ratio of amine, such as a primary amine, to tannin present is from about 1.5:1-3.0:1. Exemplary tannin/amine compounds include tannin/melamine/formaldehyde polymers such as those sold by Tramfloc Inc. and tannin/monoethanolamine/formaldehyde polymers such as are sold by GE.

The second component of the treatment composition is a metal containing inorganic coagulant. Exemplary metal containing inorganic coagulants include salts of the bivalent or trivalent metals. Such salts include the chlorides, sulfates, nitrates, and acetates of calcium, magnesium, aluminum, iron, strontium, barium, tin, or zinc. Aluminum based coagulants such as aluminum sulfate, aluminum ammonium sulfate, aluminum potassium sulfate, and aluminum chlorohydrate as well as its inorganic polymerized forms may all be mentioned as exemplary and are referred to herein under the generic description as “alum”. Iron based coagulants include ferric and ferrous salts and their inorganic polymerized forms.

As referred to above, the treatment compositions of the invention are non-destructive in nature and use thereof in the desired algae containing aqueous medium will not release algae toxin to the water body. The starch based coagulants are also widely used in drinking water treatment.

Filtration is a major process for water treatment of algae contaminated water body. Algae can foul membranes or other types of filters (e.g., multi-media filters) and greatly decrease filtration flux and contaminate the filters. Traditional ways to remove algae from water systems include adding algaecide to kill them, but the release of algae toxin into water body is a huge health risk concern. Currently, Chinese drinking water policy requires microcystin levels in drinking water of no higher than 1 ppb. This level is easily reached if blue-green algae are killed in the desired water system. Thus, in one exemplary embodiment, we add an effective amount of cationic quaternary ammonium starch and alum to the water system followed by filtration to remove living algae from the water system without releasing algae toxin.

In one exemplary embodiment of the invention, an algae contaminated aqueous medium from a municipal water plant is treated with the treatment composition. The thus treated water is then filtered in a microfilter and/or ultrafiltration step. These type of filtration steps are, per se, known in the art. For example, these steps may involve filtration through skeins of hollow fibers, each fiber having pores in the skin or fiberwall necessary to achieve the desired filtration efficacy. Commonly, average pore diameters chosen for MF (microfiltration) range from about 0.08 μm to about 2.0 μm, preferably from about 0.1-1 μm. Suitable pore sizes for ultrafiltration may be on the order of about 0.01 μm to about 0.1 μm. In accordance with known techniques, a vacuum may be drawn on the lumens of the hollow fibers to assist in the filtering.

Suitable filtering media are shown, for example, in U.S. Pat. No. 6,899,812 wherein skeins of hollow fiber membranes are disclosed with one or both ends of each fiber connected to a suitable header member. The hollow fiber membranes may, for example, be composed of organic polymers such as polysulfones, poly(styrenes), PVDF (polyvinylidene fluoride) and PAN (polyacrylonitrile) including styrene containing copolymers such as acrylonitrile-styrene, butadiene-styrene, and styrene-vinylbenzylhalide copolymers, polycarbonates, cellulosic polymers, polypropylene, poly(vinyl chloride), poly(ethylene terephthalate) and the like as disclosed in U.S. Pat. No. 4,230,463. Improvement in flux rate through the membrane and decrease in filtering time are demonstrated in algae contaminated municipal wastewater when treated in accordance with the invention.

In algae harvesting either for removing algae from algae contaminated water bodies or for biofuel oil production, an efficient dewatering method is needed. In another embodiment, an aqueous mass of algae is effectively dewatered while not killing or destroying the algae. The non-destructive method is desired because it will not release the algae toxin to the surrounding water body.

The treatment composition may be added to the aqueous medium having algae contained therein, neat or in solution, either continuously or intermittently. The effective amount of the treatment may be within the range of about 1-1,000 ppm of the 1) cationic polymer and from about 1-1,000 ppm of the 2) metal containing inorganic coagulant, based on one million parts of the aqueous medium.

### EXAMPLES

The invention will now be further described with reference to the following examples which are to be regarded solely as illustrative and not as restricting the scope of the invention.

### Example 1

### Experimental Test on Filtration Treatment of Algae Bloom Water

Microcystis aerugenosa, one of the major blue-green algae species, was cultured in Bristol medium to OD₄₃₀>2.0, and, then diluted about 10 times to OD₄₃₀=0.2 using tap water in order to simulate the real algae density in natural water body heavily contaminated by algae bloom. 250 ml diluted algae sample was added in different beakers for Time-to-Filtration test. Chemicals were added to each beaker, well mixed by magnetic stirring for 2 minutes. Precipitations were observed in 5 minutes. 200 ml well mixed sample from each beaker was filtered through 0.22 μm filter unit (Corning 250 ml Filter System, Cat. No. 431096) using 51 kPa vacuum pump, and filtration time was recorded. All filtered samples were taken for COD and microcystin toxin analysis. Results for filtration time are shown in Table 1.

TABLE 1
Standard Filtration Test

| Treatment | Filtration Speed (ml/min) |
|---|---|
| none (control) | 10.5 |
| polymer A—10 ppm | 8.6 |
| F-1—50 ppm | 16.2 |
| F-1 50 ppm/polymer A 5 ppm | 23.7 |
| F-1 50 ppm/polymer A 10 ppm | 34.1 |

It can be seen that the filtration rate is substantially increased with addition of both F-1 at 50 ppm and Polymer A at 10 ppm. A significant synergistic effect was observed. F-1 is an Al₂(OH)₅Cl-aluminum chlorohydrate product with an active content of 50%. Polymer A is described above.

COD results are shown in Table 2.

TABLE 2
COD Removal Test

| Treatment | COD (ppm) |
|---|---|
| control | 74 |
| control-fil | 23 |
| F-1 50 ppm | 15 |
| polymer A 10 ppm | 15 |
| F-1 50 ppm/polymer A 10 ppm | 17 |
| F-1 50 ppm/polymer A 5 ppm | 16 |

Compared to the original sample or the filtrate without addition of treatment, all coagulant aided filtration decreased COD content in the filtrate.

TABLE 3
Microcystin Detection

| Treatment | Microcystin Level ppb |
|---|---|
| original sample (no treatment) | 0.07 |
| Cl₂ treatment | >2.00 |
| F-1 50 ppm/polymer A 10 ppm | 0.05 |
| F-1 50 ppm/polymer A 5 ppm | 0.05 |

Microcystin toxin poses a big risk to humans. The chlorine treatment of algae contaminated water killed algae but released high toxin levels. The inventive treatment did not destroy the algae, and the toxin level of the filtrate was maintained at the same level of the original water sample.

### Example 2

### Experimental Test on Filtration Treatment of Algae Bloom Water

Microcystis aerugenosa, one of the major blue-green algae species, was cultured in Bristol medium to OD₄₃₀>4.0, and then diluted about 10 times to OD₄₃₀=0.4 using tap water in order to simulate the real algae density in natural water body contaminated by algae bloom. 250 ml diluted algae sample was added in different beakers for Time-to-Filtration test. Chemicals were added to each beaker, well mixed by magnetic stirring for 2 minutes. Precipitations were observed in 5 minutes. 200 ml well mixed sample from each beaker was filtered through 0.22 μm filter unit (Corning, 250 ml Filter System, Cat. No. 431096) using 51 kPa vacuum pump, and filtration time was recorded. All filtered samples were taken for COD and microcystin toxin analysis. Results for filtration time are shown in Table 4.

TABLE 4
Standard Filtration Test

| Treatment | Filtration Speed (ml/min) |
|---|---|
| none (control) | 1.1 |
| polymer B—10 ppm | 3.1 |
| F-2—50 ppm | 5.5 |
| F-2 50 ppm/polymer B 10 ppm | 16.0 |
| F-1 50 ppm/polymer B 10 ppm | 24.6 |
| F-2 50 ppm/polymer A 10 ppm | 12.9 |

It can be seen that the filtration rate is substantially increased with addition of both F-2 at 50 ppm and Polymer B at 10 ppm, F-1 at 50 ppm and Polymer B at 10 ppm, and F-2 at 50 ppm and Polymer A at 10 ppm. A significant synergistic effect was observed. F-1 is an alum based coagulant product with an active content of 50%. F-2 is &poly ferric sulfate coagulant (powder form, Fe³⁺≧21% by weight). Polymer A is described above and is about 31% actives (by weight). Polymer B is a copolymer of tannin/AETAC wherein the weight percentage of AETAC is about 57.5%. The molecular weight is about 75,000.

COD results are shown in Table 5.

TABLE 5
COD Removal Test

| Treatment | COD (ppm) |
|---|---|
| control | 102 |
| control-fil | 7 |
| polymer B—10 ppm | 4 |
| F-2—50 ppm | 8 |
| F-2 50 ppm/polymer B 10 ppm | 3 |
| F-1 50 ppm/polymer B 10 ppm | 4 |
| F-2 50 ppm/polymer A 10 ppm | 5 |

Compared to the original sample or the filtrate without addition of treatment, all synergistic coagulant aided filtration decreased COD content in the filtrate.

TABLE 6
Microcystin Detection

| Treatment | Microcystin Level (ppb) |
|---|---|
| original sample (no treatment) | 0.03 |
| Cl₂ treatment | >2.00 |
| F-2 50 ppm/polymer B 10 ppm | 0.03 |
| F-1 50 ppm/polymer B 10 ppm | 0.04 |
| F-2 50 ppm/polymer A 10 ppm | 0.04 |

Microcystin toxin poses a big risk to humans. The chlorine treatment of algae contaminated water killed algae but released high toxin levels. The inventive treatment did not destroy the algae, and the toxin level of the filtrate was maintained at the same level of the original water sample.

While the present invention has been described with references to preferred embodiments, various changes or substitutions may be made to these embodiments by those ordinarily skilled in the art pertinent to the present invention without departing from the technical scope of the present invention. Therefore, the scope of the present invention encompasses not only those embodiments described above, but also all that fall within the scope of the appended claims.

What is claimed is:

1. A method of treating an algae containing aqueous medium comprising adding an effective amount of a treatment composition to said aqueous medium, said treatment composition comprising 1) a water soluble or dispersible cationic polymer and 2) a metal containing inorganic coagulant.

2. A method as recited in claim 1 wherein water soluble or dispersible cationic polymer 1) comprises a member or members selected from the group consisting of a) water soluble cationic quaternary ammonium starch, b) a water soluble quaternary ammonium starch/gum blend, and c) a water soluble modified tannin.

3. A method as recited in claim 2 further comprising the step of filtering said aqueous medium.

4. A method as recited in claim 2 wherein said algae containing aqueous medium is an agglomerated mass of algae with water dispersed throughout said mass.

5. A method as recited in claim 4 further comprising the step of separating said algae from said water thereby harvesting said algae.

6. A method as recited in claim I wherein between about 1-1,000 ppm of 1) is added to said aqueous medium and from about 1-1,000 ppm of 2) is added to said aqueous medium based upon one million parts of said aqueous medium.

7. A method as recited in claim 3 wherein said aqueous medium is part of a municipal water plant treatment system.

8. The method of claim 2 wherein said water soluble cationic starch a) is present and has the formula: 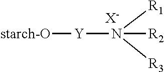
wherein X is any monovalent anion including, chloride, bromide, iodide, methyl sulfate; Y is selected from the group consisting of 2, 3 epoxy propyl, 3-halo-2-hydroxy propyl,. 2 haloethyl, o, p or m (αhydroxy-β halo ethyl)benzyl; R₁, R₂, and R₃ are independently selected from the group consisting of hydrogen, hydroxyl, alkyl, substituted alkyl, aryl and alkaryl, and in which two of the Rs (R₁, R₂, R₃) may be joined to form a heterocyclic ring compound or a homocyclic ring compound, further in which the total number of carbons in all three of R₁, R₂, and R₃ should not exceed about 14 carbons, with the proviso that if all three of R₁, R₂, and R₃ are different and R₃ contains more than 3 carbon atoms but not more than 12, then R₁ and R₂ are from the group consisting of methyl and ethyl; and if R₁ and R₂ are joined to form a ring compound, R₃ is an alkyl group not greater than ethyl wherein the concentration of starch in the composition is in the range of 7 to 30 percent by weight.

9. A method according to claim 8 wherein the starch is selected from the group consisting of corn, potato tapioca, sago, wheat, waxy maize, grain sorghum, grain starches, and dextrin.

10. A method according to claim 8 wherein the degree of substitution of the composition is in the range of 0.2 to 1.2.

11. A method according to claim 8 wherein the degree of substitution of the composition is in the range of 0.1 to 1.8.

12. A method according to claim 2 wherein said water soluble quaternary ammonium starch/gum blend b) is present, said cationic ammonium modified starch having the formula: 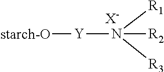
and said cationic quaternary ammonium modified gum has the formula: 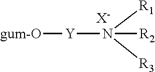
wherein X is any monovalent anion including chloride, bromide, iodide, methyl sulfate; Y is selected from the group consisting of 2,3 epoxy propyl, 3-halo-2-hydroxy propyl, 2 haloethyl, o, p or m (αhydroxy-β halo ethyl) benzyl; R₁, R₂, and R₃ are independently selected from the group consisting of hydrogen, hydroxyl, alkyl, substituted alkyl, aryl, and alkaryl, and in which two of the Rs may be joined to form a heterocyclic ring compound or a homocyclic ring compound further in which the total number of carbons in all three of R₁, R₂, and R₃ should not exceed about 14.

13. A method according to claim 12 wherein the gum is selected from the group consisting of guar, carboxylmethyl cellulose, propylene glycol alginate, locust bean karaya, sodium alginate and xanthum.

14. A method according to claim 12 wherein the starch is selected from the group consisting of corn, potato, tapioca, sago, rice wheat, waxy maize, grain sorghum, grain starches, and dextrin.

15. A method according to claim 12 wherein the degree of substitution of the composition is in the range of 0.2 to 1.2.

16. A method according to claim 12 wherein the degree of substitution of the composition is in the range of 0.1 to 1.8.

17. A method according to claim 12 wherein the concentration of gum in the composition is in the range of 5-15 starch:1 gum (by weight).

18. A method as recited in claim 2 wherein said water soluble tannin c) is present and comprises a tannin/cationic copolymer.

19. A method as recited in claim 18 wherein said tannin/cationic copolymer has a cationic repeat unit moiety comprising MADAME, METAC, or AETAC.

20. A method as recited in claim 18 wherein said water soluble tannin is present and comprises a reaction product of tannin, aldehyde, and amine.

21. A method as recited in claim 1 wherein said metal containing inorganic coagulant comprises a salt of a bivalent or trivalent metal.

22. A method as recited in claim 21 wherein said metal containing inorganic coagulant contains alum.

23. A method as recited in claim 21 wherein said metal containing inorganic coagulant contains bivalent (ferrous) or trivalent (ferric) irons.
